(19) United States
(12) Patent Application Publication
(10) Pub. No.: US 2014/0019259 A1
(43) Pub. Date: Jan. 16, 2014

(54) Methods and systems for charity operations in a social network

(71) Applicant: VIET PHU PAYMENT SERVICES SUPPORT CORPORATION, Ho Chi Minh (VN)

(72) Inventors: Trung Dung, Ho Chi Minh (VN); Hao My Diep, Ho Chi Minh (VN)

(21) Appl. No.: 13/941,366

(22) Filed: Jul. 12, 2013

Related U.S. Application Data
(60) Provisional application No. 61/670,603, filed on Jul. 12, 2012.

(51) Int. Cl. G06Q 30/02

(52) U.S. Cl. CPC G06Q 30/0273
USPC 705/14.69

(57) ABSTRACT

Methods and systems for promoting charity donations are provided, in which a person's contributions to a charity is calculated based on both monetary donations and efforts in publicizing the charity's cause in a social network. The efforts are credited with a monetary amount, allowing the person to donate actual money to a charitable cause with his work. The crediting of efforts with actual donation money can be used in a marketing campaign, in which the advertising budget is directed to charity donations with participations from members of a social network assistance.

The present application claims priority from U.S. provisional patent application Ser. No. 61/670,603, entitled “ Methods and systems for charity operations in a social network”, filed on Jul. 12, 2012, which is hereby incorporated by reference in its entirety.

### BACKGROUND

Many charities contribute to society by providing help and support to those in need. For example, charitable and non-profit organizations can provide funding for medical research, or provide aid to persons suffering from natural disasters. A large portion of the contributions to charity causes is donated by individuals. The basic reasons why individuals donate to charities includes social, psychological, and economic factors. A common technique to encourage donations from individuals is through a gift-matching program, which has been shown to have a significant effect on the likelihood and the amount of a donation.

A challenge for charitable organizations is the fundraising campaign, which can be expensive and require substantial marketing effort. Conventionally, charities have expended substantial monies and resources in an attempt to publicize their causes, and have relied on traditional marketing, such as using telemarketing or flyer distribution for fundraising and engaging donors or contributors. The fundraising campaign can typically solicit donations by advertising campaigns using media such as newspapers, magazines, television and websites. The fundraising campaign can also solicit donations by directly mailing or calling potential donors. Thus a portion of the donations to the fundraising campaign is lost toward the advertising effort.

What needed is an improved methodology to encourage charity donations, taking advantages of today's widespread social networking, together with minimizing the advertising costs.

### SUMMARY

In some embodiments, the present invention discloses methods and systems apparatuses for performing a fundraising campaign, in which a person's contribution to the charity is calculated based on monetary donation and efforts in publicizing the charity's cause. The calculated amount properly reflects the contribution of the person to the charity by accounting for monetary and non-monetary donations of the person helping the charity.

In some embodiments, the present invention discloses methods and systems for performing a marketing campaign, in which a person receives an allocation of monetary amount to be donated to selected charities for participating in the marketing campaign. The monetary allocation can be supplied from the advertisement budget of the marketing campaign, thus providing a social value to the advertising money.

### BRIEF DESCRIPTION OF THE DRAWINGS

FIG. 1 illustrates a block diagram of a fundraising campaign system, according to some embodiments.

FIGS. 2A-2B illustrate flowcharts for participating in a marketing campaign according to some embodiments.

FIG. 3 illustrates a flowchart for performing a fundraising campaign for a charity according to some embodiments.

FIG. 4 illustrates a block diagram of another marketing campaign system according to some embodiments.

FIG. 5 illustrates a flowchart for providing a marketing campaign in a social network environment according to some embodiments.

FIG. 6 illustrates another flowchart for providing a marketing campaign in a social network environment according to some embodiments.

FIG. 7 illustrates a flow chart for operating a marketing campaign with a charity focus according to some embodiments.

FIG. 8 illustrates another flow chart for operating a marketing campaign with a charity focus according to some embodiments.

FIG. 9 illustrates another flowchart for providing a marketing campaign in a social network environment according to some embodiments.

FIG. 10 illustrates a flowchart for operating a marketing campaign with charity benefits according to some embodiments.

FIG. 11 illustrates another flowchart for providing a marketing campaign in a social network environment according to some embodiments.

FIG. 12 illustrates a flowchart for providing a marketing campaign in a social network environment according to some embodiments.

FIG. 13 illustrates another flowchart for providing a marketing campaign in a social network environment according to some embodiments.

FIG. 14A illustrates an environment for implementing various aspects of the invention.

FIG. 14B is a schematic block diagram of a sample computing environment with which the present invention can interact.

### DETAILED DESCRIPTION OF THE PREFERRED EMBODIMENTS

In some embodiments, the present invention relates generally to social networking and, more particularly, to methods and systems for promoting charity campaigns or marketing campaigns between members in a social network with benefits to charitable causes.

In some embodiments, methods and systems for performing a marketing campaign are provided. The marketing campaign can be a fundraising campaign for a charity or for helping people in need. Contributions to the fundraising campaign can include monetary and non-monetary donations for the charity cause. For example, any persons, including corporate entities, can be acknowledged as contribute to the fundraising by donating money, time, effort and expertise. The non-money donations can also include the leverage of a person's social networking, such as the person can introduce the fundraising to his acquaintances, solicit the contributions of his friends, and in general, make the cause of the charity known to his contacts. The contribution of the person to the fundraising can be calculated as a combination of monetary and non-monetary donations, such as a sum of monetary donations and monetary-equivalent converted from non-monetary donations.

In some embodiments, the non-monetary donations can be converted to monetary equivalent, for example, based on a weighted formula. The fundraising campaign can allocate an amount of money to allow the conversion of the non-monetary donations. For example, a monetary donation amount, such as a dollar, can be attributed to the person who can solicit a certain amount of donations, such as a hundred dollars. The monetary donation amount can be attributed to the person's effort to introduce the fundraising to his or her social contacts, such as a dollar for every hundred fundraising introductions.

In some embodiments, the allocated amount of money can extracted from an advertising budget or from an operating budget of the fundraising campaign. Thus the portion of the donations to the fundraising campaign that is not used for charity causes can be reduced, which can increase the efficiency of the fundraising campaign.

In some embodiments, the present invention acknowledges the contribution of a person made to charities and similar organizations by accounting for the non-monetary donation of the person, such as efforts in broadcasting the charity. The proper accounting of a person's contribution can increase incentives for people to contribute to the charities, for example, by encouraging and enabling the person to donate his expertise for the charity's cause. Persons can leverage their knowledge and network to further the cause of the charity, and the contribution amount is calculated based on the work of the persons, in addition to the monetary donations. For example, the contributions of each person can be based on the number of friends, acquaintances, and contacts that the person has introduced the cause of the charity to, or has solicited donations from to the charity. In some embodiments, the present invention is applicable to collecting contributions for a charitable cause, such as an organizational fundraising, and fundraising for the public good.

The marketing campaign can be for promoting a product or a service. The marketing campaign can sponsor one or more charities, and can allocate a portion of the advertising budget or operating budget toward charity donations through the participation of members of a social network. The members can agree to promote the marketing campaign, such as posting information or blogs about the marketing campaign, or spreading information about the marketing campaign to his contacts, e.g., friends or associates. The efforts to promote the marketing campaign can be credited, by the marketing campaign, with monetary amounts that can be used toward charity donations, e.g., among the charities that the marketing campaign is sponsoring. The budgets of the marketing campaign can be used for a social cause while still obtaining the desired goal of promoting the products or services. The widespread appeal of the social network can assist in bring social values to advertising money.

In some embodiments, a marketing campaign can encourage charitable donations by individuals who use a social network. The marketing campaign can send invitation to individuals who are members of a social network to invite them to participate in the marketing campaign. The marketing campaign can be associated with one or more charities and/or a commercial goal, such as to promote a product or service. For the participation of the members in the marketing campaign, the marketing campaign can credit or allocate a monetary amount which can be used toward donations to the charities selected by the members. The monetary amount can be proportional to the participation, e.g., higher amount for more participation effort.

The participation can include accepting the invitation of the marketing campaign, for example, agreeing to promote the charity causes that the marketing campaign sponsors, or agreeing to promote the products or services of the marketing campaign. The participation can include posting or writing blogs about the charities, the products or the services sponsored by the marketing campaign. The participation can include inviting other members of the social network, such as people in the member's contact list, to participate in the marketing campaign.

In some embodiments, methods and systems are provided for promoting charitable donations by encouraging users of a social network system to use their influence to promote a marketing campaign. The marketing campaign can benefit through achieving the goal of advertising the products or services. The charities can benefit through the monetary donations by the members through the marketing campaign. The members can benefit, by knowing that their effort can bring tangible assistance to the charities.

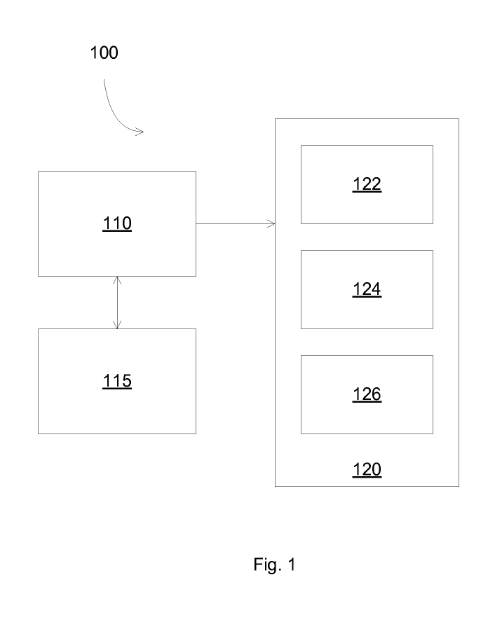

FIG. 1 illustrates a block diagram of a marketing campaign system, according to some embodiments. System 100 can include a marketing campaign engine 110, a charity campaign engine 115 and a user interface 120. System 100 can be used to conduct a marketing campaign, together with sponsoring one or more charities, and a module to utilizing social networking to assist in the marketing effort and the charity actions. For example, members of a social network can help promote the marketing campaign, in exchange for monetary amount to be donated to charity causes.

Persons can interact with user interface 120 to participate in the marketing campaign, such as participating in the promotion of the marketing campaign. Persons can interact with user interface 120 to participate in the charity activities, such as donating money or donating time, effort and expertise to the one or more charities. Activities toward promoting the marketing campaign can be converted, e.g., credited, to monetary equivalent, which can be used for donations to the charities. Direct donations can also be received by charity campaign engine 115. Marketing campaign engine 110 can calculate contribution amounts for the persons, adding monetary donations with converted non-monetary donations, e.g., monetary amount that is considered to be equivalent to the effort of the persons. Marketing campaign engine 110 can include a conversion mechanism, which can be used to convert non-monetary donations to monetary donations, based on a given relationship. The calculated contribution amounts can be disclosed and provided to the persons through user interface 120 to inform them of their respective contribution amounts that are to be donated to a charity. For example, a person can donate $100 to a given charity. The person can donate $100 to the charity campaign to put into an account for the person. Then the person can direct the charity campaign to send appropriate amounts to selected charities of the marketing campaign. Alternatively, a person can donate his effort to promote the marketing campaign. For example, the person can leverage his social network skill, such as sending solicitation about the marketing campaign to many of his contacts. His effort can be credited with a certain monetary amount, calculated by a conversion formula by the marketing campaign. The user then can use the monetary amount for charity giving, such as donating to selected charities of the marketing campaign. A combination of monetary and non-monetary can be used, and the marketing campaign can add the monetary and non-monetary donations to credit the user with appropriate monetary amount so that the user can donate to the charities of his choice.

User interface 120 can include any user interface interaction mechanism. For example, user interface 120 and marketing campaign engine 110 can be in a common computer system, or can be located in separate computer systems. User interface 120 can include a display, keyboard, mouse, and/or other user interface mechanism, to enable persons to join the marketing campaign, to input monetary donations, to publicize the campaign, and/or to be informed of contribution amounts.

User interface 120 can include information about the marketing campaign 122, such as the cause, the goals and the current status. The marketing campaign 122 can include links to other websites for more information. The marketing campaign 122 can include information about the calculated contributions, for example, for the user or for all contributors. User interface 120 can include information about monetary donation 124, such as amount inputted for donation and methods of payment. User interface 120 can include information about non-monetary donations, such as publicizing the marketing campaign by forwarding the campaign information to other persons in the user social network.

Marketing campaign engine 110 can be implemented in hardware (e.g., a computer system, electrical circuits/logic, etc.), software, firmware, or any combination thereof, to receive information about monetary and non-monetary donations, to convert the non-monetary donations to monetary donations, to credit the user with monetary amount converted from the non-monetary work, and to calculate total contribution amounts. For example, marketing campaign engine 110 can be implemented in a computer system, such as a server, a desktop computer, or a mobile computer (e.g., a handheld computer, a laptop computer, a personal digital assistant (PDA), or a mobile phone). The marketing campaign engine 110 can be provided in program code that can be executed in one or more processors of the computer system.

In some embodiments, the marketing campaign is facilitated by a computer network, such as an online social network environment. In some embodiments, the present invention can combine social networking with the concept of leveraging network contacts to solicit contributions from others. The inclusion of non-monetary contributions, such as counting the use of network contacts of a person to publicize or broadcast the products or services of the marketing campaign, can increase the incentive of members of the social network to assist in the marketing campaign. The accounting of non-monetary contributions, for example, using the social networking component of forwarding the charity event to his network contacts, can encourage potential donors to publicize the campaign. In some embodiments, the marketing campaign can allocate an initial amount of money to cover the non-monetary contributions.

Worldwide communication between individuals has been facilitated with the use of the Internet. A number of social networking services, such as Facebook and Twitter, have been developed to allow individuals to network socially over the Internet for specific purposes. In some embodiments, the invention discloses a combination of marketing and charity service, under a context of a social network, which can bring individuals together to support and raise money for charitable causes.

A social network can provide web-based access for users to interact with each other. In a typical social network, a user can chose to associate with other users, who are listed as contacts, and can be referred to as “friends”. Individual users of a social network can create a profile or web pages to include information about themselves, about their friends, written comments, etc. The users can post comments, greetings, or in general, information that they feel like sharing.

In some embodiments, users or members of a social network can use the network framework to promote activities of a marketing campaign, in exchange for a monetary account that can be used to contribute to a charity. The promotion can include posting comments about the marketing campaign on the members' home page, or sending information about the marketing campaign to their friends.

In some embodiments, it is recognized that social media networks can help in publicizing the marketing campaign via a user network contact in conjunction with promoting charity causes. Social media can be particularly well suited to broadcasting a marketing or a charity cause, as they reflect personal relationships in an online realm, resulting in millions of users exposed to the marketing or charity cause in a relatively short time. Typically, the concept of encouraging users to participate in a marketing campaign or a charity donation as disclosed herein involves counting the non-monetary effort of the users toward their total contributions to the charity causes. A user can contribute a monetary donation to the charity via a non-monetary contribution by simply introducing other users in their network contact to the marketing campaign or to the charity causes. For example, by introducing 100 of his contacts within the social media network to the marketing campaign, a 100 dollar donation (assuming a converted ratio of a dollar per contact) can be made to a charity. The marketing campaign or the charity organization can use the advertisement budget, (the money that typically spent in advertising the marketing campaign or the charity cause) to account for the converted monetary donations. In this way, the marketing campaign or the charity organization can optimize their spending power, using all available money for the charity causes. Thus, charity efficiency can be maximized, since the budget allocated toward advertisement and publicity can be returned to the charity for helping the charity cause.

As a simple example, a user on a social network such as Facebook can establish that posts using the word “IntroduceProductTo” to trigger an introduction of a product to a recipient. Thus, a user can post “IntroduceProductTo recipient for NewProduct”. Facebook can recognize the reserved word “IntroduceProductTo” and trigger a processing service to parse the post, extract the information necessary, and possibly conduct a confirmation or disambiguation process with the user. After the details are ready, the system can send a message to the recipient, informing the recipient of the New Product. In return, the user can receive a monetary amount to be used for a charity donation of his choice.

In some embodiments, the present invention describes methods and apparatuses for promoting marketing campaign or charity causes and for encouraging charitable donations by individuals who use the social network. A user can invite members and non-members to join his market support, which can result in monetary benefits for his charity causes. An invitation may be sent by email or any other means of notification, such as private message, instant message, mail, text message, fax, or phone. The message can be automatically input by the system or manually input by the user. The user can post comments about the marketing campaign or charity causes.

In some embodiments, the methods can encourage charitable donations through a social network where a user may raise awareness for a specific product or service through a marketing campaign, by inviting other users to support the marketing campaign. The non-monetary effort of the users can be converted to a monetary donations, thus the users can assist the charity in both monetary contributions and publicizing of the charity cause.

In some embodiments, the present invention discloses a method of encouraging charitable donations through a social network. The non-monetary efforts of the users of the social network can be converted and count as monetary donations, thus properly account for the users effort in helping the charity.

A method for marketing campaign with charity benefit in a social network can include sending invitations to members or users of a social network to participate in the marketing campaign. The members can also send an invitation to one or more members or non-members. For example, the invitation can include an invitation to participate in the marketing campaign, such as agreeing to support the marketing campaign, agreeing to introducing other contacts to join or participate in the marketing campaign. The efforts in promoting the marketing campaign can be credited with monetary donations to selected charities, for example, the members of the social network, after participating to the marketing campaign, can receive notices of a monetary amount in their account, which can be used to donate to charities.

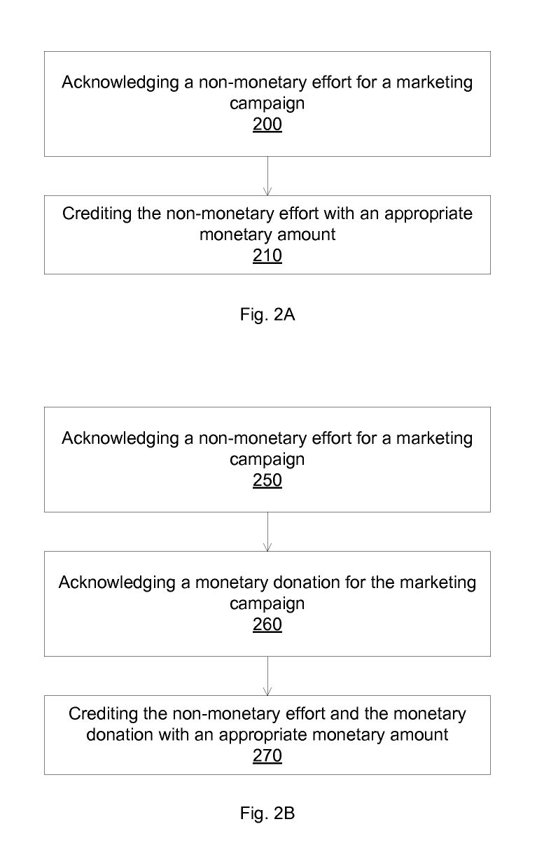

FIGS. 2A-2B illustrate flowcharts for participating in a marketing campaign according to some embodiments. In FIG. 2A, non-monetary efforts are credited with monetary amount to be used for donation to a charity. The non-monetary efforts can include activities that promote a marketing campaign, such as agreeing to participate in the marketing campaign, or introducing other members of the social network to the marketing campaign. In operation 200, a marketing campaign can acknowledge a non-monetary effort by a member of a social network. For example, the marketing campaign can send an invitation to the member to participate in the marketing campaign. After agreeing to, a member can send notice to the marketing campaign to inform the marketing campaign of his decision. In operation 210, the marketing campaign can credit the member with an appropriate monetary amount to be used in a charity donation. For example, the marketing campaign can create an account for the member and set the balance of the account to the monetary credited to the member. After receiving notice from the member regarding the disposition of the account, the marketing campaign can send the money to the charities selected by the member.

The monetary amount credited to the member can be related to the efforts of the member in promoting the marketing campaign. For example, a first amount can be attributed to the member's account after agreeing to participate in the marketing campaign. A second amount can be attributed to the member's account after the member performs certain promotion activities, such as inviting other members in his contacts to participate in the marketing campaign or posting information about the marketing campaign in his home page.

In FIG. 2B, non-monetary efforts and monetary donations are credited with monetary amount to be used for donation to a charity. In operation 250, a marketing campaign can acknowledge a non-monetary effort by a member of a social network. In operation 260, the marketing campaign can acknowledge a monetary donation the member of a social network toward charity donations. In operation 270, the marketing campaign can credit the member with an appropriate monetary amount, e.g., the sum of monetary donation and monetary amount converted from the non-monetary effort, to be used in a charity donation.

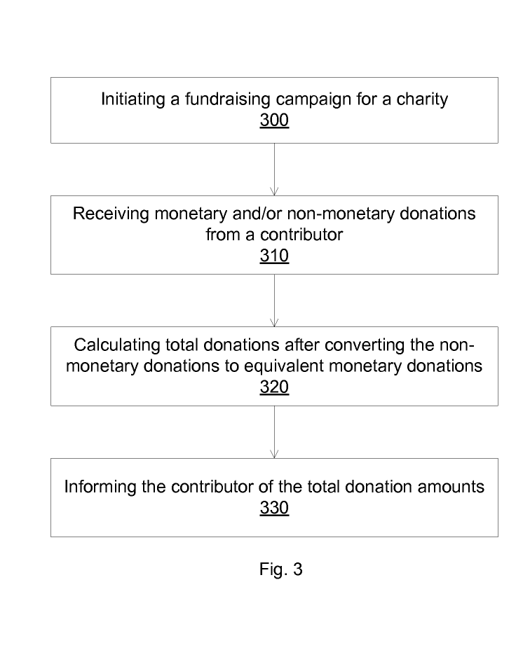

FIG. 3 illustrates a flowchart for performing a fundraising campaign for a charity according to some embodiments. For example, the fundraising campaign system described above can be used to implement the flowchart. In some embodiments, further structural and operational embodiments can be added. In addition, some operations can be optional and can be omitted.

In operation 300, a charity cause can initialize a fundraising campaign, for example, by supplying information about the charity, together with a list of donors and donor contributions. For example, a campaign organizer can start a fundraising campaign for a charity which can provide help to persons in need. Any charity can be selected, such as an individual, or a charitable organization. A fundraising campaign can be initiated by specifying the objective of the campaign, such as a monetary other goal, and by providing a list of charities to receive the contributions.

In some embodiments, the charity can allocate a budget to cover for the conversion of non-monetary donations to monetary donations of the donors or contributors. The fundraising campaign can include one or more charities and goals, such as a financial goal or a participation goal. The campaign can include images and links to an external web page. For example, a link may be provided to a web page that lists facts about the charity cause. In some embodiments, one or more charitable causes can be active simultaneously at any given time.

In embodiments, the campaign organizer can invite individuals and organizations to participate in the charity fundraising campaign. For example, the campaign organizer can send an email, text message, or letter to the invitees. In addition, others can join the campaign without invitation, for example, through advertisements or other techniques that attract participants to the charity.

The fundraising campaign can send messages to one or more users of a social network, inviting them to participate in the campaign. The messages can include information about the user potential contributions, including the conversion of non-monetary donations to monetary donations. For example, by accepting to participate in the campaign or by broadcasting or publicizing the charity cause, the users can effectively make a monetary donation to the charity. The monetary donations can be contributed by the charity, for example, by taken from the advertisement budget of publicizing the charity. In addition, the users can directly donate money to the charity.

In operation 310, the fundraising campaign receives monetary donations and non-monetary contributions from users of a social network. The non-monetary donations can include effort to publicize the charity cause, such as inviting other users to join the campaign.

In operation 320, total donations from the users are calculated. For example, the non-monetary donations can be converted to monetary donations, and added together. In some embodiments, the campaign encourages the user to invite other users in their social network to support the campaign by donating money or by publicizing the charity cause. By recognizing non-monetary donations, like effort, as monetary donations, the charity can provide the users with more charity giving power, thus encouraging the users to reach out and invite other users to join the charity cause. The other users can be invited by email or any other communication means provided by the social network. For example, the users can send an email to potential new participants with information such as a description of the campaign, and a total amount of money donated to the campaign. The receiving users can also have the benefits, e.g., the charity power giving, of the sending users, including the conversion of non-monetary donations to monetary donations.

In operation 330, the value of the donations by each user can be displayed and informed to the users, such as by email communication or by posting on the charity website. For example, the users can see the details of all the donations made to the campaign to date. The users can see their own donations to the campaign. The donation listing can show the donation by each contributor, for example, in order of date, e.g., latest donation appearing first, or in order of value, e.g., highest donation appearing first.

In some embodiments, a charity is introduced to a person. The introduction can be in the form of an email, inviting the person to contribute to the charity cause, either in monetary donations or non-monetary donations. The person can be aware of the charity, for example, during visits to a website or visiting the charity's site. The person can be convinced of the charity's cause, and can then decide to contribute to the fundraising campaign immediately or at a later time. For example, the person can donate money to the charity, and/or introduce the charity cause to his acquaintances. The person can forward the fundraising introduction to persons in his contact list, with or without a personal note promoting the charity event. Software can be included to facilitate the charity promotion. The contribution of the person to the charity is then calculated, based on a certain relationship which can convert the non-monetary donations to the monetary donations. For example, an invitation of the person to one of his contacts to participate in the charity event can be counted as a fraction of his monetary donation, or can be counted as a dollar amount. Each person is informed of the calculated contribution, and the charity can maintain a record of all calculated contributions.

The contribution conversion can be calculated in any manner. For example, by accepting to participate in the charity, the person can have a converted monetary contribution amount. An introduction for the charity without a corresponding note can earn a smaller contribution than an introduction with a personal note.

In some embodiments, the present invention discloses a system for performing a charity campaign, which can include a charity campaign engine. The charity campaign engine can be configured to receive monetary and non-monetary donations from each person. The charity campaign engine can be configured to calculate contribution amounts for all persons, including the conversion of non-monetary donations to monetary donations, and publicly displayed at the charity website.

In some embodiments, the present invention discloses a method of performing a charity campaign. The method includes introducing a charity to a person. For example, a person can be notified of the charity cause and operation. The introduction can be performed by electronic communication, such as by email, by a social network, by an online advertisement, or by internet. In some embodiments, the charity can be introduced by an invitation sent to or received by the person, such as an email or a message. Alternatively, the person can visit a website of the charity, or respond to an advertisement to visit the charity website. The charity can be introduced by another person forwarding an invitation to participate in the charity, or to send or receive a message regarding the charity. The invitation can include a notification of the charity, or can include a solicitation to contribute to the charity.

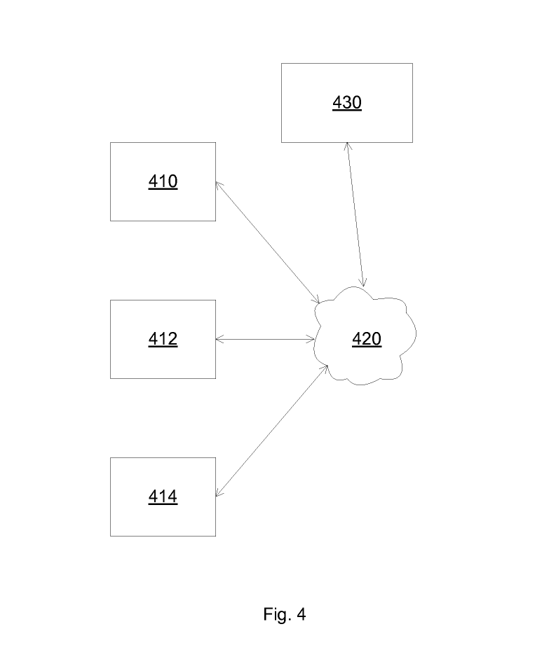

FIG. 4 illustrates a block diagram of another marketing campaign system according to some embodiments. Marketing campaign system 400 can include multiple computers 410, 412, and 414, a network 420, and a marketing campaign engine 430. Any number of computers can be present in system. Computers can be any type of computer, including server, desktop, or mobile. Marketing campaign engine 430 can include instructions and information to operate a marketing campaign, such as a marketing campaign engine described above. In some embodiments, persons use computers to associate with a social network. The campaign engine provides information about the product, service and charitable cause, and to solicit participation and/or donations from the social network users. Network 420 can be any type of communication network, such as a local area network (LAN) or wide area network (WAN), or a combination of networks, such as the Internet.

Persons can participate in the campaign, e.g., donating services in any manner, for example, through a website, email, text messaging, telephone, etc. In some embodiments, the persons are users of a social network, and communicate to the campaign server and other users by the network connection. For example, the user of a first computer can use a browser to access a social network. The campaign engine can send an email to the user, providing information about the marketing products and services, together with sponsored charities, and can provide information to the user about how to participate in the campaign. The user can contribute to the charity, for example, by a monetary donation of sending a payment, or by a non-monetary donation of forwarding the marketing information to another user, such as a user within the social network.

In some embodiments, the marketing campaign can include a setup, for example, by creating a homepage and/or fan page for the marketing products, services and charitable causes. Minimum to no programming expertise is necessary. For example, the homepage can include a short description of the charity cause support, a link to more information on the charity cause, the total campaign pledge, the current campaign donation, the remaining balance, the contributing persons, and the top 10 contributors that have total impact on the campaign.

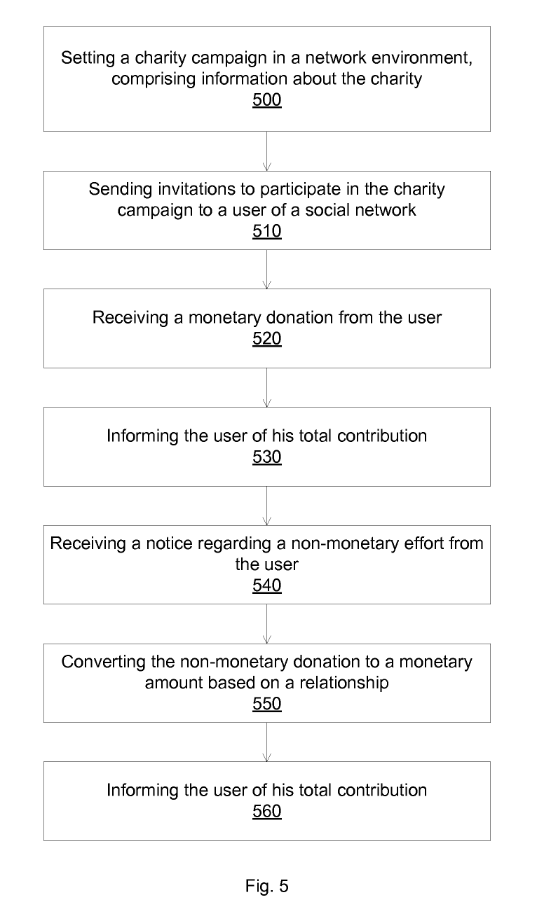

FIG. 5 illustrates a flowchart for providing a marketing campaign in a social network environment according to some embodiments. In operation 500, a social network, such as Facebook, can be used to provide basic Facebook user data about this campaign. A simple setup can include different categories of contributors, such as like, follow, or friends of the campaign. The setup can include status report, progress history report, for example, to keep track of the participating network for each participating user for this campaign, and to post regular campaign updates to participating users. The setup can include channel for discussion about the campaign within the network, such as discussion channels for all participating users. The setup can allow users to updates to his activities regularly.

In operation 510, the campaign can send invitations to key personnel of the social network. The key personnel can include employees of the campaign, friends of the campaign, or celebrities who support the campaign. After the campaign setup, a person can receive a campaign invitation on his home page, such as an email notification. The campaign invitation can have sufficient information about the campaign, together with the link to campaign home page.

In operation 520, the user of the social network can optionally send donations to the campaign for donating to the charities that the campaign sponsors. The monetary donation can include money donating to the charity. After receiving the monetary donation (operation 520), the campaign can inform the user of his donation (operation 530).

In operation 540, the campaign receives a notice regarding a non-monetary effort from the user. For example, the non-monetary effort can include agreeing to participate in the campaign, to promote the products and services that the campaign supports, and/or to invite other members of the social network to the campaign. In general, the non-monetary effort can include time and work performed for the campaign. For example, the non-monetary contribution can include introducing the campaign to other persons. In some embodiments, the non-monetary contribution can include sending information regarding the campaign to the contacts in a social network contact list of the person. In some embodiments, the campaign information is provided to the social network of the person, with instructions to participate in the campaign. For example, the participation can include agreeing to participate in the campaign. The participation can include publicizing the products and services of the campaign, or to broadcast the campaign. The instructions can include simplified actions to ease the time and effort of the person. For example, one or more clicks can be performed to forward the invitation of the campaign to all contacts in the person's contact list. Personal notes can also be included in the forwarding messages.

In operation 550, the campaign can convert the non-monetary contribution or effort to an equivalent monetary donation. The method can include calculating contribution amounts for the person based on the monetary donation and non-monetary donation received from the person. In general, the contribution can include money, time, and effort, and thus the non-monetary donations can be counted toward the contribution. The non-monetary can be converted to a monetary amount, for example, by a predetermined relationship. For example, a dollar can be counted for each person that the person sends the invitation to. The person can automatically receive a certain monetary donation in his charity account, once the person accepts the invitation to join the campaign. The person can invite friends to join campaign, with or without a personalized message. And for every friend that accepts the invitation, the person will receive an amount to his contribution account.

After converting the non-monetary donation to monetary donation, the total contribution amount of the person can be calculated by adding the two (monetary and non-monetary) donations. The calculated contribution can be updated every time the person performs work for the campaign. For example, each time the person forwards the invitation of the campaign to another person on his contact list, the calculated contribution is updated. In some embodiments, an initial amount of money is allocated, for example, by the campaign, to cover the non-monetary donations.

The method can include informing the person of the calculated contribution amount (operation 560). The calculated contribution can be sent to the person, or can be listed on the campaign website. For example, the person can see his contribution on the campaign home page or on his home page.

In some embodiments, the present invention discloses methods to operate a marketing campaign in a network environment. The methods can account for a user's non-monetary effort, and thus can add an equivalent monetary amount to the user account to be used for charity donation. The equivalent monetary donation can be allocated at the beginning of the campaign, for example, using the advertisement budget as the compensation for the non-monetary effort or contribution. High efficiency can be realized, since a large portion of the budget is allocated toward the charity cause itself, stemming from the elimination or reduction of the overhead spending of advertisement. High participation of contributors can also be realized, since the participants can feel that they can make a larger difference in helping others with a non-monetary contribution equivalent to a monetary donation that is larger than their budget allows.

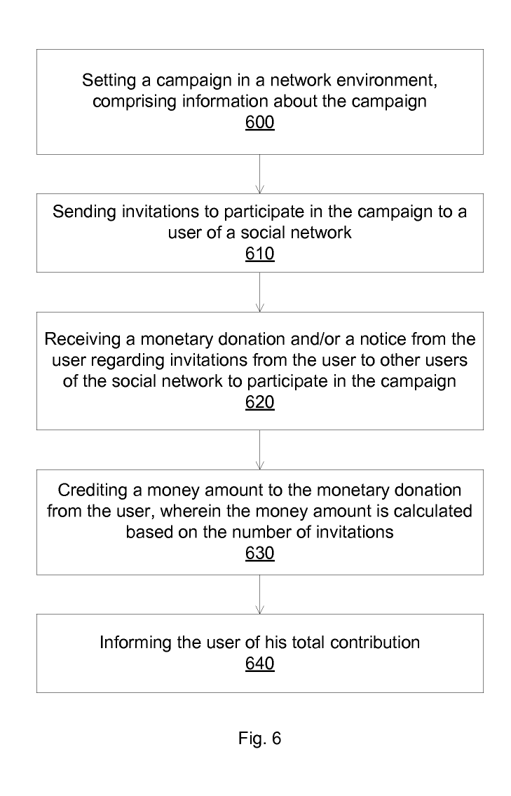

FIG. 6 illustrates another flowchart for providing a marketing campaign in a social network environment according to some embodiments. In operation 600, a marketing campaign is set up, including information about the products and services that the marketing campaign supports. The campaign can allocate a budget to cover the non-monetary efforts of the contributors. In operation 610, invitations are sent to potential contributors to invite them to participate in the campaign. The potential contributors can be selected based on their inclination toward supporting the products and services. In operation 620, donations are credited toward the user account for charity donations. Donations can include monetary donation. Donations can include notices from the users informing the campaign of the user actions to publicize the campaign, such as forwarding the invitations of the campaign to other users in his social network. In operation 630, the campaign converts the non-monetary donations to monetary donations, for example, based on a relationship with the number of forwarded invitations. The campaign then adds a money amount based on the converted non-monetary donations to the monetary donations. In operation 640, the campaign informs the user of his total contribution.

The campaign can continue, with the forwarded invitations sent to new users of the social network. The new users can elect to participate in the campaign, and can contribute monetary donation and non-monetary donation, such as forwarding again the invitations to new users. The campaign can continue until reaching its goals, such as reaching the marketing goal.

In some embodiments, the present invention discloses methods to operate a marketing campaign with supports for multiple charities in a network environment. The methods can establish a donation account for a user, and the user can contribute monetary donations to the account. In addition, the campaign can add equivalent monetary donations to the account based on the non-monetary donations performed by the user. The user then can use the account money to provide to selected charities within the marketing campaign.

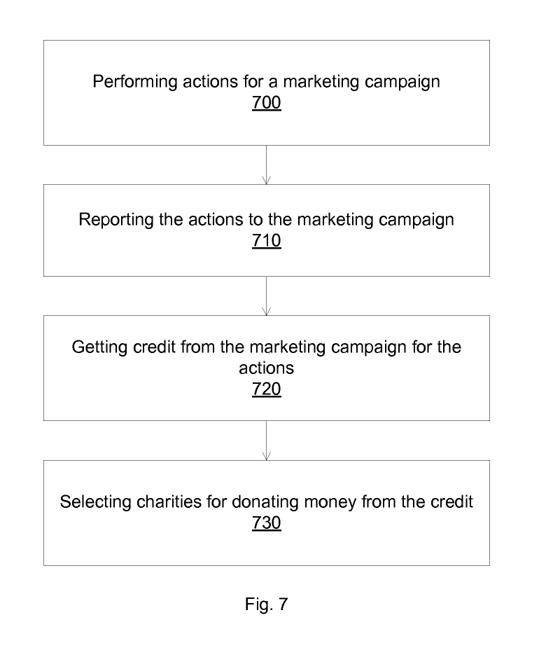

FIG. 7 illustrates a flow chart for operating a marketing campaign with a charity focus according to some embodiments. A member of a social network can perform work for a marketing campaign within his social network contact, and receive monetary credit to be used toward charity donations. In operation 700, a member of a social network can performing some actions for a marketing campaign, such as agreeing to participate in the marketing campaign, or promoting the products or services of the marketing campaign, including posting or writing blogs about the products or services, or sending invitations to his contacts or other members of the social network to participate in the marketing campaign. In operation 710, the member can report his activities to the marketing campaign. In some embodiments, the activity reporting action can be automatic, or can be simple to do, such as clicking to an agreement button.

In operation 720, the member can receive credits from the marketing campaign for the activities that he performs for the marketing campaign. The credits can be actual money, which can be used toward donation to a charity. The credits can be allocated in an account of the member, hosted by the marketing campaign. In operation 730, the member can select charities for donating money from the credits received from the marketing campaign. For example, the member can inform the marketing campaign to take a certain amount from his account to send to a charity that he selected. In some embodiments, the charity can be a charity among the charities that the marketing campaign sponsors and supports.

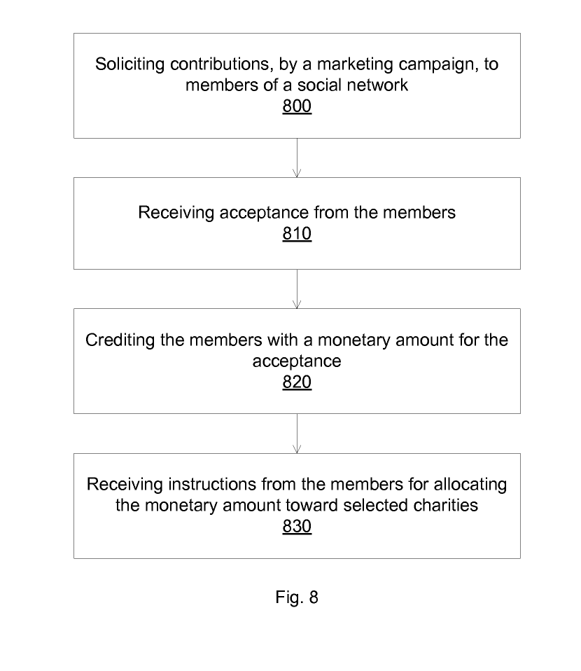

FIG. 8 illustrates another flow chart for operating a marketing campaign with a charity focus according to some embodiments. A marketing campaign can solicit contributions from a member of a social network. The contributions can include promoting the marketing campaign, including agreeing to participate in the marketing campaign, providing advertisement for the products and services of the marketing campaign, and inviting other members of the social network to participate in the marketing campaign. In operation 810, the marketing campaign can receive an acceptance notice from the member. The acceptance notice can be simple, such as clicking on an agreement button, and a reply can be automatically sent to the marketing campaign. The terms of the acceptance can include allowing the marketing campaign to use the member's information in promoting the marketing campaign, agreeing to participate in the marketing campaign, such as writing comments and evaluations of the products and services of the marketing campaign, and agreeing to promote the marketing campaign, such as letting friends, contacts, and other members of the social network know about the products and services of the marketing campaign.

In operation 820, the marketing campaign can credit the member with a monetary amount for the acceptance. In operation 830, the marketing campaign can receive instructions from the member for allocating the money in the monetary amount to a charity that the member selects.

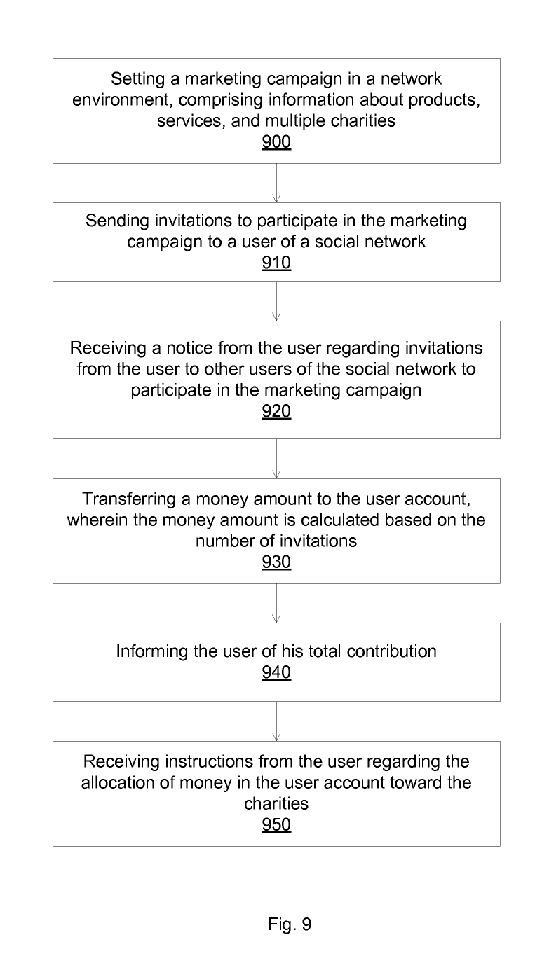

FIG. 9 illustrates another flowchart for providing a marketing campaign in a social network environment according to some embodiments. In operation 900, a marketing campaign is set up, including information about the products and services of the campaign, together with multiple supported charities and/or lists of donor contributions. The marketing campaign can allocate a budget to cover the activities of the contributors. In operation 910, invitations are sent to potential contributors to invite them to participate in the campaign. In operation 920, notices about the activities are received. Activities can include monetary donation, which can be included in the user account. Activities can include notices from the users informing the campaign of the user actions to publicize the campaign, such as forwarding the invitations of the campaign to other users in his social network. In operation 930, the campaign converts the activities to monetary credits, for example, based on a relationship with the number of forwarded invitations. The campaign then transfers a money amount based on the converted activity credit to the user account. In operation 940, the campaign informs the user of his total contribution. In operation 950, the campaign receives instructions from the user regarding the allocation of the money in his account toward selected charities.

The campaign can continue, with the forwarded invitations sent to new users of the social network. The new users can elect to participate in the campaign, and can contribute monetary donation and converted activity credits, such as forwarding again the invitations to new users. The campaign can continue until reaching its goals.

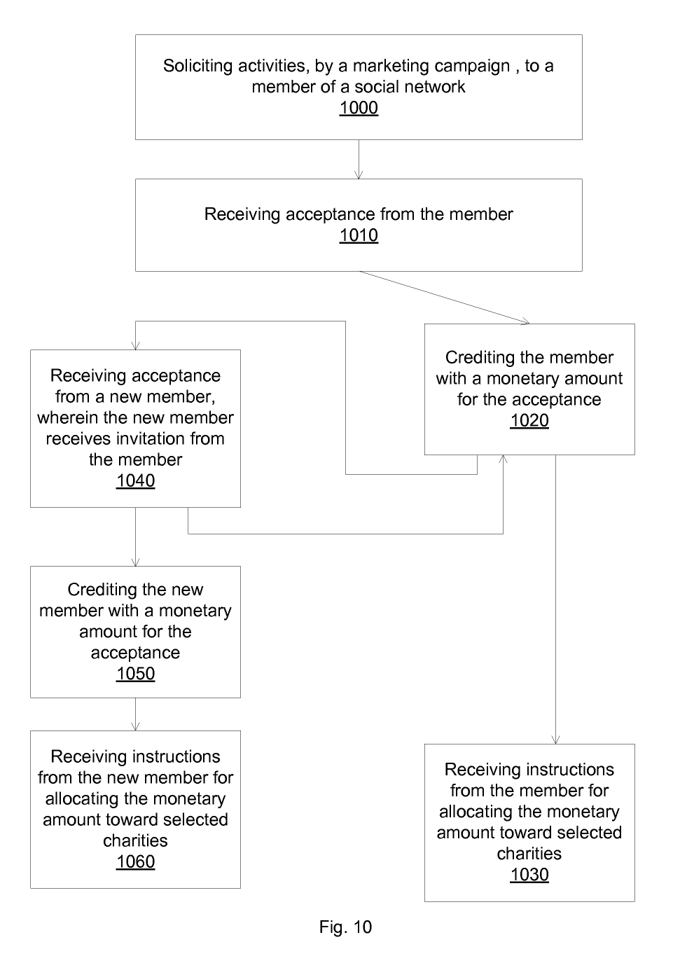

FIG. 10 illustrates a flowchart for operating a marketing campaign with charity benefits according to some embodiments. In operation 1000, a marketing campaign can solicit contributions from a member of a social network. In operation 1010, the marketing campaign can receive acceptance from the member. In operation 1020, the marketing campaign can credit the member with a monetary amount for the acceptance. In operation 1040, the marketing campaign can receive acceptances from new members, who have received invitations from the member. In operation 1050, the marketing campaign can credit the new members with a monetary amount in their accounts for the acceptances. The marketing campaign can also credit the member with an addition monetary amount in his account for the acceptances of the new members. In operations 1060 and 1030, the marketing campaign can receive instructions from the member and the new members regarding the allocation of the money in the accounts toward selected charities.

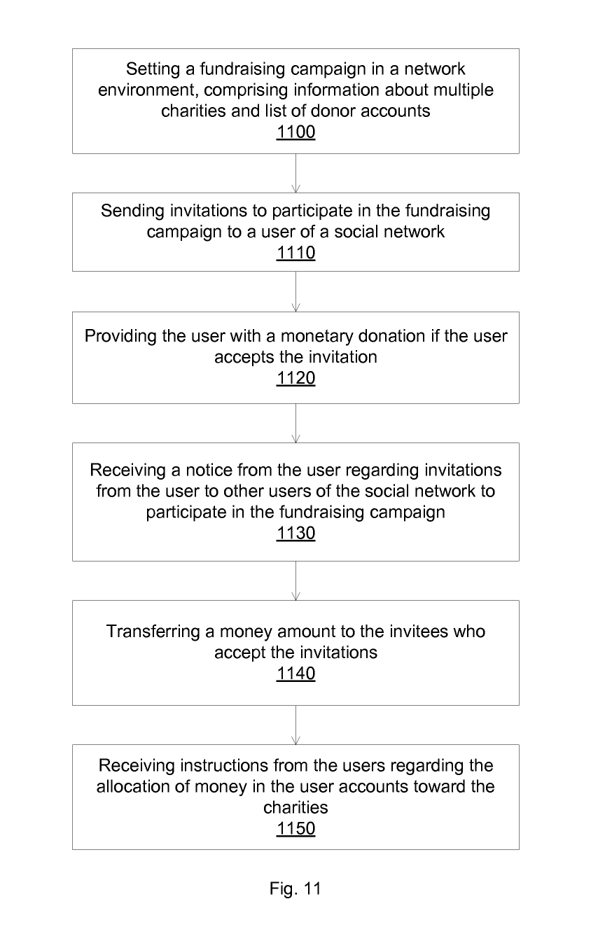

FIG. 11 illustrates another flowchart for providing a marketing campaign in a social network environment according to some embodiments. In operation 1100, a marketing campaign is set up, including information about the products and services of the marketing campaign, together with information about the multiple supported charities. The marketing campaign can allocate a budget to cover the activities of the contributors. In operation 1110, invitations are sent to potential contributors to invite them to participate in the marketing campaign. In operation 1120, a monetary donation can be allocated to the user account if the user accepts the invitation. In operation 1130, the user forwards the invitations to other users. In some embodiments, the forwarding action is a condition of the user accepting to participate in the marketing campaign. In operation 1140, a monetary donation can be allocated to each user who accepts the forwarded invitation. In operation 1150, the users direct the money in his accounts toward selected charities.

In some embodiments, the present invention discloses a marketing campaign for new services, new products, new brands, or survey of key concepts. For example, for a marketing budget, the campaign can reach a number of users on a social network depending on a predetermined donation amount per invitation. The actual numbers will depend on the total budget from the company and the donation per invitee. Each of these users will have spent 3-5 minutes reading about the programs, the charity causes and the product promotion and can actively send out further invites to the friends in their network.

The marketing campaign can have a social impact. For example, the company can achieve its marketing goals while most of its marketing budget actually goes to the charities. Traditionally, the marketing money would be spent on billboards, TV ads, magazines or newspaper advertisements. In the present invention, the money will go toward the charity instead. Thus, the company can build a good standing in the market among social network users. The company can also provide many social network users with an opportunity to do charitable giving to the charity of their interests. The users can feels that they can make a larger impact, which includes their monetary donations together with the converted donations through the invitations of people on their network contact list. The larger impact can play an important psychological role in the users participating in the campaign.

The following description illustrates an example of a marketing campaign. Company A would like to introduce a new line of product and would like to employ a creative marketing campaign process that can have a high social impact. Company A can allocate a budget for the marketing campaign, and select a charitable cause. The charitable cause can be a traditional charitable cause, such as medical research, or social condition improvements. The charitable cause can be a timely charitable cause, and the company can run its marketing campaign right when these events are happening and get the maximum emotional impact from the users. For example, when a natural disaster happens, the company can immediately run a social marketing campaign and can expect to get significant participation from the social network community.

The company can then design a social network campaign page, such as a Facebook page, which can describe the charity goal, and the description of products and/or services. The Facebook page can start with some initial fans, such as employees, friends and family, or a few well-known or influence fans.

The company can then send invitations with a message to its fans. The message can include a charity message and a product promotion message. In some embodiments, the product promotion message is shown when a user accepts the invitation. The message can ask users to forward the invitation to their friends to support charity causes. The message can notify the user that the user has received an amount of money in his charity account, which can be used to donate to the charity, or other charities within the marketing campaign context. The message can also notify the user that additional money can be transferred to his charity account upon his effort to help with the charity cause, such as sending invitations to other persons in his Facebook friends. The user can then use his charity account to support a charity of his choice.

In some embodiments, the user, after accepting the invitation to participate in the marketing campaign, can receive an amount of money allocated for his account. The user can then use his account to support one or more charities promoted by the marketing campaign. Optionally, the user can donate his own money to his account to further support his selected charities. In addition, the user can forward the invitation from the marketing campaign to all or some of his friends.

In some embodiments, the user can receive an equivalent monetary donation in his account based on the number of invitations that he sent out. The user then can use the money in his account to support the charities of his choice. In some embodiments, the recipients of the user's invitations can receive an amount of money allocated in their accounts as well. The recipients can use their account monies to support the charities of their choices. The cycle can continue, with money in the accounts donated to the charities. The campaign can also continue until its goal is reached, for example, until the total giving reach the total limit from the company.

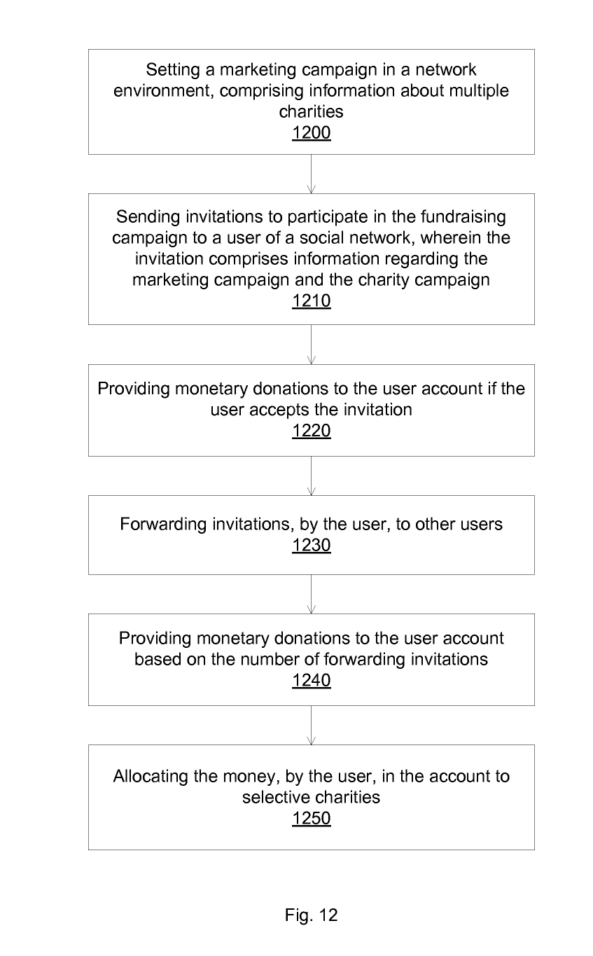

FIG. 12 illustrates a flowchart for providing a marketing campaign in a social network environment according to some embodiments. In operation 1200, a marketing campaign is set up, including information about the products, or the services that are to be advertised, together with information about multiple supported charities. The marketing campaign can allocate a budget to cover the non-monetary donation, e.g., activities, of the contributors. In operation 1210, invitations are sent to potential contributors to invite them to participate in the marketing campaign. The invitations can include information regarding the marketing campaign, such as the products or the services that the marketing campaign wished to be introduced. In operation 1220, a monetary donation can be allocated to the user account if the user accepts the invitation. In operation 1230, the user can forward the invitations to other users. In operation 1240, additional monetary allocation can be provided to the user account based on the number of sent invitations. In operation 1250, the user directs the money in his account toward selected charities.

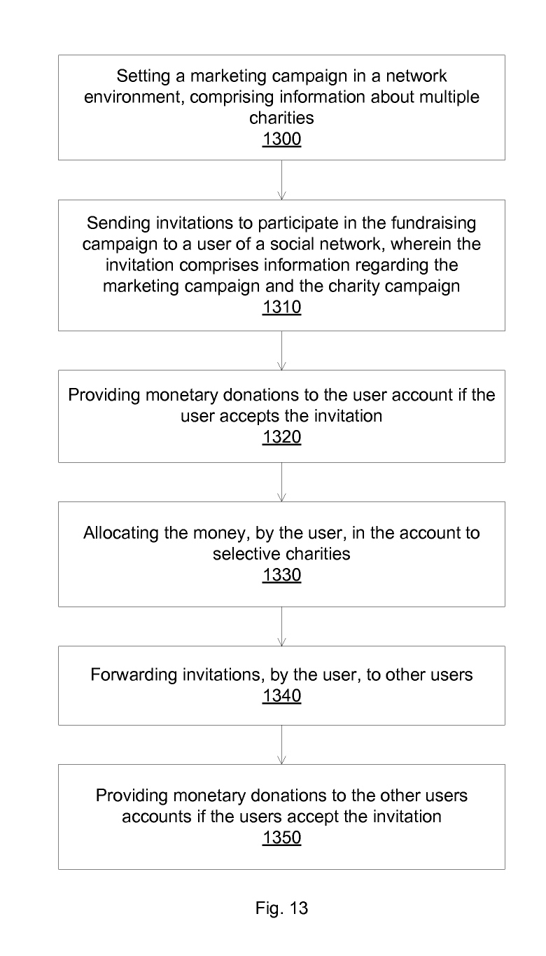

FIG. 13 illustrates another flowchart for providing a marketing campaign in a social network environment according to some embodiments. In operation 1300, a marketing campaign is set up, including information about the products, or the services that are to be advertised, together with information about multiple supported charities. The marketing campaign can allocate a budget to cover the non-monetary donation of the contributors. In operation 1310, invitations are sent to potential contributors to invite them to participate in the marketing campaign. The invitations can include information regarding the marketing campaign, such as the products or the services that the marketing campaign wished to be introduced. In operation 1320, a monetary donation can be allocated to the user's account if the user accepts the invitation. In operation 1330, the user directs the money in his account toward selected charities. In operation 1340, the user forwards the invitations to other users. In some embodiments, the forwarding action is a condition of the user accepting to participate in the marketing campaign. In operation 1350, a monetary donation can be allocated to each user who accepts the forwarded invitation. The user then can use the money in his account for donating to selective charities.

The present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, e.g. a processor.

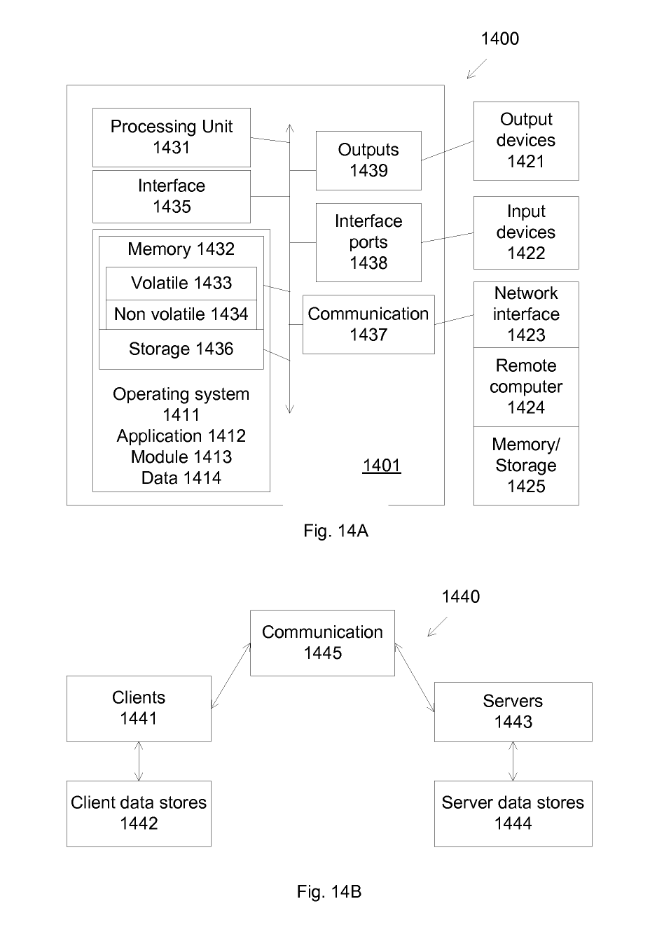

FIG. 14A illustrates an environment for implementing various aspects of the invention, which includes a computer 1401, comprising a processing unit 1431, a system memory 1432, and a system bus 1430. The processing unit 1431 can be any of various available processors, such as single microprocessor, dual microprocessors or other multiprocessor architectures. The system bus 1430 can be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1432 can include volatile memory 1433 and nonvolatile memory 1434. Nonvolatile memory 1434 can include read only memory (ROM), programmable ROM (PROM), electrically programmable ROM (EPROM), electrically erasable ROM (EEPROM), or flash memory. Volatile memory 1433, can include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

Computer 1401 also includes storage media 1436, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1435 can be used to facilitate connection.

The computer system 1401 further can include software to operate in environment 1400, such as an operating system 1411, system applications 1412, program modules 1413 and program data 1414, which are stored either in system memory 1432 or on disk storage 1436. Various operating systems or combinations of operating systems can be used.

Input devices 1422 can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1438. Interface ports 1438 can include a serial port, a parallel port, a game port, a universal serial bus (USB), and a 1394 bus. The interface ports 1438 can also accommodate output devices 1421. For example, a USB port may be used to provide input to computer 1401 and to output information from computer 1401 to an output device 1421. Output adapter 1439, such as video or sound cards, is provided to connect to some output devices such as monitors, speakers, and printers.

Computer 1401 can operate in a networked environment with remote computers 1424. The remote computers 1424, shown with a memory storage device 1425, can be a personal computer, a server, a router, a network PC, a workstation, a microprocessor based appliance, a peer device or other common network node and the like, and typically includes many or all of the elements described relative to computer 1401. Remote computers 1424 can be connected to computer 1401 through a network interface 1423 and communication connection 1437, with wire or wireless connections. Network interface 1423 can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

FIG. 14B is a schematic block diagram of a sample computing environment 1440 with which the present invention can interact. The system 1440 includes a plurality of client systems 1441. The system 1440 also includes a plurality of servers 1443. The servers 1443 can be used to employ the present invention. The system 1440 includes a communication network 1445 to facilitate communications between the clients 1441 and the servers 1443. Client data storage 1442, connected to client system 1441, can store information locally. Similarly, the server 1443 can include server data storages 1444.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

What is claimed is:

1. A computer-implemented method comprising:
receiving, by a marketing campaign, a notice of a non-monetary contribution from a member of a social network;
crediting the member with a monetary amount, wherein the monetary amount is configured to be donated to one or more charities, wherein the one or more charities are sponsored by the marketing campaign.

2. A method as in claim 1 further comprising
allocating an amount of money to be used for crediting the non-monetary contribution.

3. A method as in claim 2 wherein the amount of money is allocated from an advertisement budget or an operating budget of the marketing campaign.

4. A method as in claim 1 further comprising
sending, by a marketing campaign, an invitation to the member to participate in the marketing campaign.

5. A method as in claim 1 wherein a non-monetary contribution comprises accepting the invitation.

6. A method as in claim 1 wherein a non-monetary contribution comprises promoting the marketing campaign, by the member, in the social network.

7. A method as in claim 1 wherein a non-monetary contribution comprises posting information about the marketing campaign, by the member, in the social network.

8. A method as in claim 1 wherein a non-monetary contribution comprises providing a blog by the member about the marketing campaign in the social network.

9. A method as in claim 1 wherein a non-monetary contribution comprises providing, by the member, a link about the marketing campaign in the social network.

10. A method as in claim 1 wherein a non-monetary contribution comprises promoting the marketing campaign, by the member, to contacts of the member in the social network.

11. A method as in claim 1 wherein a non-monetary contribution comprises inviting other members of the social network to participate in the marketing campaign.

12. A method as in claim 1 wherein a non-monetary contribution comprises sending invitations, by the member, to other members of the social network to participate in the marketing campaign, wherein the other members are selected from a list of contacts of the member.

13. A method as in claim 1 further comprising
receiving a monetary donation from the member, wherein the monetary donation is configured to be donated to the one or more charities.

14. A method as in claim 1 further comprising
receiving a notice from the member for donating at least a portion of the monetary amount to a charity.

15. A method as in claim 1 further comprising
receiving, by a marketing campaign, a notice of another non-monetary contribution from the member;
crediting the member with another monetary amount.

16. A system comprising:
a first module for receiving notices of a non-monetary contribution from members of a social network;
a second module for crediting the members with monetary amounts, for processing the monetary amount toward donations to one or more charities.

17. A system as in claim 16 wherein a non-monetary contribution comprises promoting a marketing campaign, by the member, in the social network.

18. A system as in claim 16 wherein a non-monetary contribution comprises sending invitations, by the member, to other members of the social network to participate in a marketing campaign, wherein the other members are selected from a list of contacts of the member.

19. A machine readable medium including contents that are configured to cause data processing system to perform a method comprising
receiving, by a marketing campaign, a notice of a non-monetary contribution from a member of a social network;
crediting the member with a monetary amount, wherein the monetary amount is configured to be donated to one or more charities, wherein the one or more charities are sponsored by the marketing campaign.

20. A machine readable medium as in claim 19 wherein the method further comprises
receiving, by a marketing campaign, a notice of another non-monetary contribution from the member;
crediting the member with another monetary amount.
